(19) United States
(12) Patent Application Publication
(10) Pub. No.: US 2026/0298736 A1
(43) Pub. Date: Oct. 1, 2026

(54) SENSOR DEVICE AND FILM

(71) Applicant: SINTOKOGIO, LTD., Nagoya-shi (JP)

(72) Inventors: Yoshikane TANAAMI, Nagoya-shi (JP); Miyuki HAYASHI, Nagoya-shi (JP)

(73) Assignee: SINTOKOGIO, LTD., Nagoya-shi (JP)

(21) Appl. No.: 19/545,749

(22) Filed: Feb. 20, 2026

(30) Foreign Application Priority Data
Mar. 31, 2025 (JP) 2025-059057

(51) Int. Cl. G01L 1/22; G01L 1/18; G01L 1/26

(52) U.S. Cl. CPC G01L 1/2287; G01L 1/18; G01L 1/22; G01L 1/2206; G01L 1/2231; G01L 1/26

(57) ABSTRACT

To provide a sensor device in which the time required for mounting a plurality of strain gauges can be reduced and variation is unlikely to occur in the positional relationship among the plurality of strain gauges, irrespective of the shape and material of a strain element. The sensor device includes a strain element and a film on which a plurality of strain gauges are formed, the film being bonded to the strain element.

This Nonprovisional application claims priority under 35 U.S.C. § 119 on Patent Application No. 2025-059057 filed in Japan on Mar. 31, 2025, the entire contents of which are hereby incorporated by reference.

### TECHNICAL FIELD

The present invention relates to a sensor device that senses force and/or torque. Further, the present invention relates to a film for use in such a sensor device.

### BACKGROUND ART

Sensor devices that sense force and/or torque, such as a force sensor that senses force, a torque sensor that senses torque, and a force sensor that senses force and torque, have been widely used. In such sensor devices, a configuration is employed in which strain of a strain element caused by the application of force and/or torque is electrically sensed by using a plurality of strain gauges bonded to the strain element.

To manufacture such a sensor device, it is necessary to individually bond each of a plurality of strain gauges to a strain element. Thus, there arises a problem in that the implementation of the strain gauges is time-consuming. In addition, it is required to individually determine the positions where the strain gauges are bonded to the strain element. Thus, there arises a problem in that variation is likely to occur in the positional relationship among the plurality of strain gauges. When such variation occurs in the positional relationship among the strain gauges, it is difficult to mass-produce high-accuracy force sensors.

As a document disclosing a technology that may contribute to solving such problems, Patent Literature 1 can be cited. Patent Literature 1 discloses a technique for sensing strain of an insulating substrate, which is a strain element, using strain gauges directly formed on a surface of the strain element by a sputtering process.

### Citation List

### Patent Literature

[Patent Literature 1]

Japanese Patent Application Publication, Tokukai, No. 2003-139504

### SUMMARY OF INVENTION

### Technical Problem

However, the sensor device to which the technique disclosed in Patent Literature 1 can be applied is limited to a sensor device that uses, as a strain element, a substrate on which strain gauges can be directly formed by a sputtering process. Thus, a technology capable of solving the abovementioned problems irrespective of the shape and material of the strain element has not been realized.

An aspect of the present invention has been made in view of such circumstances, and an object thereof is to provide a sensor device in which the time required for mounting a plurality of strain gauges can be reduced and variation is unlikely to occur in the positional relationship among the plurality of strain gauges, irrespective of the shape and material of a strain element.

### Solution to Problem

A sensor device in accordance with an aspect of the present invention includes: a strain element, and a film on which a plurality of strain gauges are formed, the film being bonded to the strain element.

A film in accordance with an aspect of the present invention is a film configured to be bonded to a strain element, the film including a plurality of strain gauges that are formed on the film.

### Advantageous Effects of Invention

According to an aspect of the present invention, it is possible to provide a sensor device in which the time required for mounting a plurality of strain gauges can be reduced and variation is unlikely to occur in the positional relationship among the plurality of strain gauges, irrespective of the shape and material of a strain element.

### BRIEF DESCRIPTION OF DRAWINGS

FIG. 1 is an exploded perspective view of a force sensor in accordance with an embodiment of the present invention.

FIG. 2 is a plan view of the force sensor illustrated in FIG. 1.

FIG. 3 is a cross-sectional view of the force sensor illustrated in FIG. 1.

FIG. 4 illustrates a first variation of the force sensor illustrated in FIG. 1, in which (a) is a plan view of one film provided in the force sensor in accordance with the first variation, and (b) is a plan view of the other film provided in the force sensor in accordance with the first variation.

FIG. 5 is a cross-sectional view of a strain element provided in the force sensor illustrated in FIG. 4.

FIG. 6 is an exploded perspective view of a second variation of the force sensor illustrated in FIG. 1.

### DESCRIPTION OF EMBODIMENTS

The present embodiment describes the configuration, advantageous effects, and variations of a force sensor, which is an example of a sensor device. Note, however, that the scope of application of the present invention is not limited to the force sensor. That is, the present invention can be applied to sensor devices of any type capable of electrically sensing strain of a strain element with use of strain gauges. In addition to the force sensor that senses both a force and a torque, the present invention is also applicable, for example, to a force sensor that senses a force and to a torque sensor that senses a torque.

### Example Configuration of Force Sensor

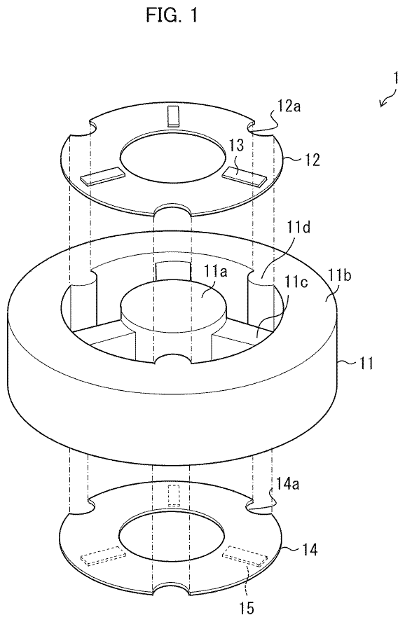

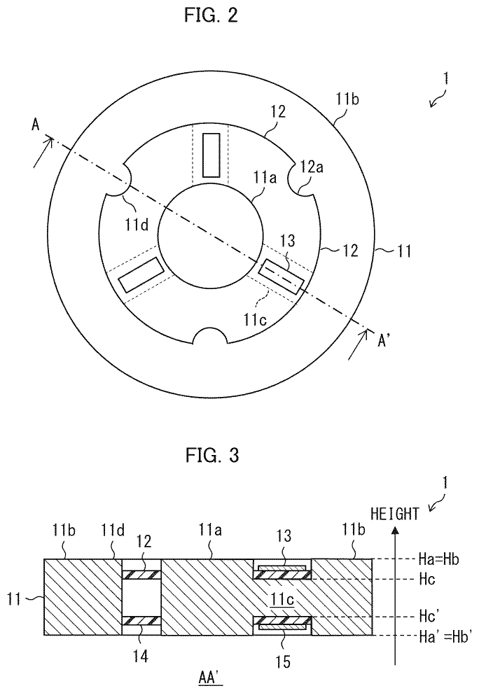

A force sensor 1 in accordance with Embodiment 1 of the present invention will be described with reference to FIGS. 1 to 3. FIG. 1 is an exploded perspective view of the force sensor 1, FIG. 2 is a plan view of the force sensor 1, and FIG. 3 is a cross-sectional view of the force sensor 1.

The force sensor 1 includes a strain element 11, a film 12 bonded to an upper face of the strain element 11, and a film 14 bonded to a lower face of the strain element 11. On the film 12, a plurality of strain gauges 13 are formed. On the film 14, a plurality of strain gauges 15 are formed.

The strain element 11 has a core portion 11a, a frame portion 11b, and a beam portion 11c. Examples of materials of the strain element 11 may include metallic materials such as an aluminum alloy and a stainless alloy, or resin materials such as an epoxy resin and a polyurethane resin. In any case, the core portion 11a, the frame portion 11b, and the beam portion 11c are integrally molded.

The core portion 11a is a columnar structure. In the present embodiment, a structure having a circular cross-section orthogonal to the central axis, that is, a cylindrical structure is used as the core portion 11a, but this is not limited thereto. That is, the cross-sectional shape of the core portion 11a is not particularly limited.

The frame portion 11b is a tubular structure surrounding the core portion 11a. The frame portion 11b is arranged such that the central axis of the frame portion 11b coincides with the central axis of the core portion 11a, and an inner side face of the frame portion 11b faces a side face of the core portion 11a. In the present embodiment, a structure having an annular cross-section orthogonal to the central axis, that is, a tubular structure is used as the frame portion 11b, but this is not limited thereto. That is, the cross-sectional shape of the frame portion 11b is not particularly limited.

The beam portion 11c is a columnar structure that connects the core portion 11a and the frame portion 11b. The beam portion 11c is disposed in a space defined between the side face of the core portion 11a and the inner side face of the frame portion 11b such that the central axis of the beam portion 11c is orthogonal to the central axis of the core portion 11a. In the present embodiment, a structure having a rectangular cross-section orthogonal to the central axis, that is, a quadrangular prism-shaped structure is used as the beam portion 11c, but this is not limited thereto. That is, the cross-sectional shape of the beam portion 11c is not particularly limited. In this embodiment, the core portion 11a and the frame portion 11b are connected by three beam portions 11c arranged such that the central axes form angles of 120°, but this is not limited thereto. That is, the number of beam portions 11c is not particularly limited.

On the inner side face of the frame portion 11b, a protrusion 11d extending in parallel with the central axis of the frame portion 11b is formed. In the present embodiment, the protrusion 11d having a semi-circular cross-section orthogonal to the central axis is used, but this is not limited thereto. That is, the cross-sectional shape of the protrusion 11d is not particularly limited. As described later, the protrusion 11d is a structure that facilitates alignment between the strain element 11 and the film 12. The protrusion 11d may have, on its upper face, an attachment hole for attaching a cover that covers an upper face of the force sensor 1. Similarly, the protrusion 11d may have, on its lower face, an attachment hole for attaching a cover that covers a lower face of the force sensor 1.

The film 12 is a film-like structure bonded to the upper face of the strain element 11. Examples of materials of the film 12 may include resin materials such as polyimide. In the present embodiment, an annular polyimide film having an inner peripheral radius that matches the radius of the upper face of the core portion 11a and an outer peripheral radius that matches the inner peripheral radius of the upper face of the frame portion 11b is used as the film 12, but this is not limited thereto. That is, the material and shape of the film 12 are not particularly limited. On the upper face of the film 12, the plurality of strain gauges 13 are formed. Each strain gauge 13 may include, for example, at least a pair of strain sensing elements and wirings connected to the respective strain sensing elements. Examples of materials of the strain gauges 13 may include alloy materials such as chromium nitride, but this is not limited thereto. In addition, on the upper face of the film 12, a protective film (not illustrated) that covers the strain gauges 13 may be deposited.

In the strain element 11, with any plane orthogonal to the central axis of the core portion 11a serving as a reference plane, the height Hb of the upper face of the frame portion 11b is the same as the height Ha of the upper face of the core portion 11a. In addition, the height Hc of the upper face of each beam portion 11c is lower than the heights Ha =Hb of the upper faces of the core portion 11a and the frame portion 11b (see FIG. 3). The film 12 is disposed in a space defined between the side face of the core portion 11a and the inner side face of the frame portion 11b, and the lower face of the film 12 is bonded to the upper faces of the beam portions 11c. Bonding between the lower face of the film 12 and the upper faces of the beam portions 11c may be performed by using, for example, an adhesive.

Here, the film 12 is bonded to the upper faces of the beam portions 11c after being aligned such that the plurality of strain gauges 13 coincide with the respective beam portions 11c. To facilitate this alignment, at least one recess 12a is formed on the outer periphery of the film 12. This alignment is achieved by appropriately rotating the film 12 so that the recess 12a formed on the outer periphery of the film 12 engages with the protrusion 11d formed on the inner side face of the frame portion 11b.

It is to be noted that differences between the heights Ha =Hb of the upper faces of the core portion 11a and the frame portion 11b, and the height Hc of the upper face of each beam portion 11c, that is, Ha−Hc=Hb−Hc, are greater than the thickness of the entire film 12 including the strain gauges 13 and the protective film (see FIG. 3). Accordingly, even when the cover that covers the upper face of the force sensor 1 is not provided, the entire film 12 is completely accommodated in a space defined between the side face of the core portion 11a and the inner side face of the frame portion 11b, so that damage to the strain gauges 13 due to contact with an object is unlikely to occur.

In addition, the height Ha of the upper face of the core portion 11a and the height Hb of the upper face of the frame portion 11b may be the same or may be different. However, when the upper face of the force sensor 1 is covered with the cover, it is preferable that the height Ha of the upper face of the core portion 11a be not more than the height Hb of the upper face of the frame portion 11b.

The film 14 is a film-like structure bonded to the lower face of the strain element 11. In the present embodiment, an annular polyimide film having an inner peripheral radius that matches the radius of the lower face of the core portion 11a and an outer peripheral radius that matches the inner peripheral radius of the lower face of the frame portion 11b is used as the film 14, but this is not limited thereto. That is, the material and shape of the film 14 are not particularly limited. On the lower face of the film 14, the plurality of strain gauges 15 are formed. Each strain gauge 15 may include, for example, at least a pair of strain sensing elements and wirings connected to the respective strain sensing elements. Examples of materials of the strain gauges 15 may include alloy materials such as chromium nitride, but this is not limited thereto. In addition, on the lower face of the film 14, a protective film (not illustrated) that covers the strain gauges 15 may be deposited.

In the strain element 11, with any plane orthogonal to the central axis of the core portion 11a serving as a reference plane, the height Hb′ of the lower face of the frame portion 11b is the same as the height Ha′ of the lower face of the core portion 11a. In addition, the height Hc′ of the lower face of the beam portion 11c is higher than the heights Ha′=Hb′ of the lower face of the core portion 11a and the frame portion 11b (see FIG. 3). The film 14 is disposed in a space defined between the side face of the core portion 11a and the inner side face of the frame portion 11b, and the upper face of the film 14 is bonded to the lower faces of the beam portions 11c. Bonding between the upper face of the film 14 and the lower faces of the beam portions 11c may be performed by using, for example, an adhesive.

Here, the film 14 is bonded to the lower faces of the beam portions 11c after being aligned such that the plurality of strain gauges 15 coincide with the respective beam portions 11c. To facilitate this alignment, at least one recess 14a is formed on the outer periphery of the film 14. This alignment is achieved by appropriately rotating the film 14 so that the recess 14a formed on the outer periphery of the film 14 engages with the protrusion 11d formed on the inner side face of the frame portion 11b.

It is to be noted that differences between the heights Ha′=Hb′ of the lower faces of the core portion 11a and the frame portion 11b, and the height Hc′ of the lower face of each beam portion 11c, that is, Hc′−Ha′=Hc′−Hb′, are greater than the thickness of the entire film 14 including the strain gauges 15 and the protective film (see FIG. 3). Accordingly, even when the cover that covers the lower face of the force sensor 1 is not provided, the entire film 14 is completely accommodated in a space defined between the side face of the core portion 11a and the inner side face of the frame portion 11b, so that damage to the strain gauges 15 due to contact with an object is unlikely to occur.

It is to be noted that, in the present embodiment, the configuration is employed in which the protrusions 11d are formed on the inner side face of the frame portion 11b and the recesses 12a are formed on the outer periphery of the film 12, but this is not limited thereto. For example, a configuration may be employed in which recesses are formed on the inner side face of the frame portion 11b and protrusions are formed on the outer periphery of the film 12.

In addition, the height Ha′ of the lower face of the core portion 11a and the height Hb′ of the lower face of the frame portion 11b may be the same or may be different. However, when the lower face of the force sensor 1 is covered with the cover, it is preferable that the height Ha′ of the lower face of the core portion 11a be not less than the height Hb′ of the lower face of the frame portion 11b.

It is to be noted that, in the present embodiment, the configuration is employed in which the plurality of protrusions 11d having the same shape are formed on the inner side face of the frame portion 11b and the plurality of recesses 12a having the same shape are formed on the outer periphery of the film 12, but this is not limited thereto. A configuration may be employed in which a single protrusion 11d is formed on the inner side face of the frame portion 11b and a single recess 12a is formed on the outer periphery of the film 12, or alternatively, a configuration may be employed in which a plurality of protrusions 11d having different shapes are formed on the inner side face of the frame portion 11b and a plurality of recesses 12a having different shapes are formed on the outer periphery of the film 12. This allows elimination of a degree of freedom in rotation of the film 12 in alignment.

### Production Method of Film

The film 12 (including the strain gauges 13), which is bonded to the upper face of the strain element 11, may be manufactured, for example, as follows.
Step 1: A film (for example, a polyimide film) is bonded onto a glass substrate.
Step 2: A plurality of strain gauges 13 are simultaneously deposited on the film. At this time, terminals for connecting wirings to the strain gauges 13 may also be deposited on the polyimide film together with the strain gauges 13.
Step 3: A protective film is deposited on the film so as to cover the strain gauges 13. It is to be noted that, when the terminals are deposited in Step 2, the protective film may be deposited so as not to cover the terminals, or alternatively, after depositing the protective film covering the terminals, parts of the protective film covering the respective terminals may be removed.
Step 4: The film is cut by laser into a predetermined shape.
Step 5: The laser-cut film is removed from the glass substrate.

The film 14 (including the strain gauges 15), which is bonded to the lower face of the strain element 11, may be manufactured in the same manner. By bonding the film 12 (including the strain gauges 13) and the film 14 (including the strain gauges 15), which are manufactured in this manner, to the strain element 11, the force sensor 1 is obtained.

### Advantageous Effects of Force Sensor

In conventional force sensors, it has been necessary, during their manufacture, to individually bond each of a plurality of strain gauges to the strain element. Thus, there has been a problem in that the mounting of the strain gauges is time-consuming. In addition, it has been necessary to individually determine the positions at which the strain gauges are bonded to the strain element. Thus, there has been a problem in that variation is likely to occur in the positional relationship among the plurality of strain gauges. When such variation occurs in the positional relationship among the strain gauges, it is difficult to mass-produce high-accuracy force sensors.

On the other hand, in the force sensor 1 in accordance with the present embodiment, during its manufacture, the plurality of strain gauges 13 can be mounted in correct positions simply by bonding the film 12 to the upper face of the strain element 11. Similarly, the plurality of strain gauges 15 can be mounted in correct positions simply by bonding the film 14 to the lower face of the strain element 11. Thus, the force sensor 1 in accordance with the present embodiment can solve the problems in that the mounting of the strain gauges 13, 15 is time-consuming and that variation is likely to occur in the positional relationship among the strain gauges 13, 15.

In the force sensor 1 in accordance with the present embodiment, instead of requiring an operation of individually bonding each of the plurality of strain gauges 13 to the strain element 11, an operation of forming each of the plurality of strain gauges 13 on the film 12 is required. Similarly, instead of requiring an operation of individually bonding each of the plurality of strain gauges 15 to the strain element 11, an operation of forming each of the plurality of strain gauges 15 on the film 14 is required.

However, the operation of forming each of the plurality of strain gauges 13 on the film 12 can be collectively carried out by a deposition process. Similarly, the operation of forming each of the plurality of strain gauges 15 on the film 14 can be collectively carried out by a deposition process. Thus, even taking into consideration the operation of forming each of the plurality of strain gauges 13 on the film 12 and the operation of forming each of the plurality of strain gauges 15 on the film 14, the time required to manufacture the force sensor 1 in accordance with the present embodiment is shorter than the time required to manufacture conventional force sensors. In addition, compared with variation in the positional relationship among a plurality of strain gauges in conventional force sensors, variation in the positional relationship among the plurality of strain gauges 13, 15 in the force sensor 1 in accordance with the present embodiment is smaller.

### First Variation of Force Sensor

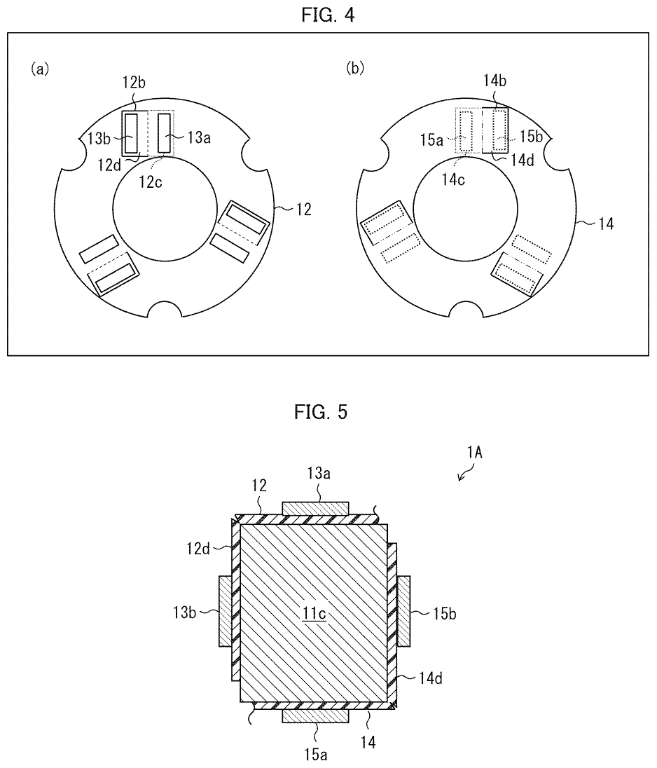

A first variation of the force sensor 1 (hereinafter referred to as “force sensor 1A”) will be described with reference to FIGS. 4 and 5. (a) of FIG. 4 is a plan view of the film 12 provided in the force sensor 1A, and (b) of FIG. 4 is a plan view of the film 14 provided in the force sensor 1A. FIG. 5 is a cross-sectional view of a beam portion 11c of the strain element 11 to which the films 12 and 14 are bonded.

Similar to the force sensor 1 illustrated in FIG. 1, the force sensor 1A in accordance with the present variation includes a strain element 11, a film 12 bonded to the upper face of the strain element 11, and a film 14 bonded to the lower face of the strain element 11. Differences between the force sensor 1 illustrated in FIG. 1 and the force sensor 1A in accordance with the present variation are as follows.

Difference 1: On the upper face of the film 12 included in the force sensor 1, a strain gauge 13 configured to be arranged on the upper face of the corresponding one of the beam portions 11c is formed, as illustrated in FIG. 1. In contrast, as illustrated in (a) of FIG. 4, on the upper face of the film 12 included in the force sensor 1A in accordance with the present variation, in addition to a first strain gauge 13a configured to be arranged on the upper face of the beam portion 11c, a second strain gauge 13b configured to be arranged on a side face of the beam portion 11c are formed. The second strain gauge 13b is arranged, on the upper face of the film 12 included in the force sensor 1A, in a second region 12d adjacent to a first region 12c in which the first strain gauge 13a is arranged.

Difference 2: In the film 12 included in the force sensor 1, no cut line is formed, as illustrated in FIG. 1. In contrast, in the film 12 included in the force sensor 1A in accordance with the present variation, a cut line 12b that surrounds three sides of the second region 12d except for the boundary with the first region 12c is formed, as illustrated in (a) of FIG. 4.

Due to these differences, in the force sensor 1A in accordance with the present variation, the film 12 can be bent so that the boundary line between the first region 12c and the second region 12d serves as a ridge line. As a result, as illustrated in FIG. 5, the first region 12c can be bonded to the upper face of the beam portion 11c and the second region 12d can be bonded to the side face of the beam portion 11c. Thus, the first strain gauge 13a can be arranged on the upper face of the beam portion 11c and the second strain gauge 13b can be arranged on the side face of the beam portion 11c.

Difference 3: On the lower face of the film 14 included in the force sensor 1, a strain gauge 15 configured to be arranged on the lower face of the corresponding one of the beam portions 11c is formed, as illustrated in FIG. 1. In contrast, as illustrated in (b) of FIG. 4, on the lower face of the film 14 included in the force sensor 1A in accordance with the present variation, in addition to a third strain gauge 15a configured to be arranged on the lower face of the beam portion 11c, a fourth strain gauge 15b configured to be arranged on a side face of the beam portion 11c are formed. The fourth strain gauge 15b is arranged, on the lower face of the film 14 included in the force sensor 1A, in a fourth region 14d adjacent to a third region 14c in which the third strain gauge 15a is arranged.

Difference 4: In the film 14 included in the force sensor 1, no cut line is formed, as illustrated in FIG. 1. In contrast, in the film 14 included in the force sensor 1A in accordance with the present variation, a cut line 14b that surrounds three sides of the fourth region 14d except for the boundary with the third region 14c is formed, as illustrated in (b) of FIG. 4.

Due to these differences, in the force sensor 1A in accordance with the present variation, the film 14 can be bent so that the boundary line between the third region 14c and the fourth region 14d serves as a ridge line. As a result, as illustrated in FIG. 5, the third region 14c can be bonded to the lower face of the beam portion 11c and the fourth region 14d can be bonded to the side face of the beam portion 11c (the side face opposite to the side face to which the second region 12d is bonded). Thus, the third strain gauge 15a can be arranged on the lower face of the beam portion 11c and the fourth strain gauge 15b can be arranged on the side face of the beam portion 11c (the side face opposite to the side face to which the second strain gauge 13b is arranged).

### Second Variation of Force Sensor

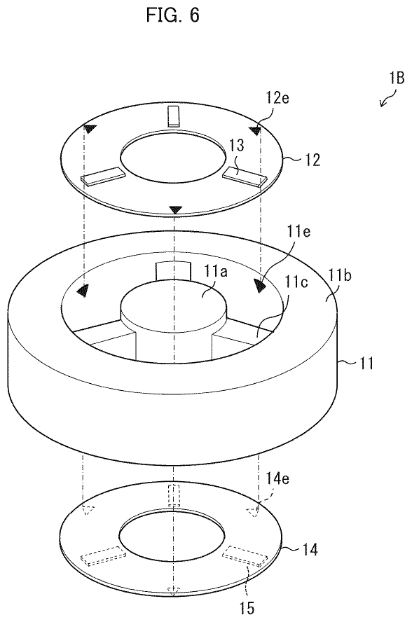

A second variation of the force sensor 1 (hereinafter referred to as “force sensor 1B”) will be described with reference to FIG. 6. FIG. 6 is an exploded perspective view of the force sensor 1B.

The force sensor 1B in accordance with the present variation includes, similar to the force sensor 1 illustrated in FIG. 1, a strain element 11, a film 12 bonded to the upper face of the strain element 11, a plurality of strain gauges 13 formed on the upper face of the film 12, a film 14 bonded to the lower face of the strain element 11, and a plurality of strain gauges 15 formed on the lower face of the film 14. Differences between the force sensor 1 illustrated in FIG. 1 and the force sensor 1B in accordance with the present variation are as follows.

Difference 1: In the force sensor 1 illustrated in FIG. 1, a recess 12a is formed on the outer periphery of the film 12 and a protrusion 11d is formed on the inner side face of the frame portion 11b. In contrast, in the force sensor 1B in accordance with the present variation, no recess is formed on the outer periphery of the film 12 and no protrusion is formed on the inner side face of the frame portion 11b. Instead, in the force sensor 1B in accordance with the present variation, an alignment mark 12e is formed on the upper face of the film 12 and an alignment mark 11e is formed on the inner side face of the frame portion 11b.

This allows the strain gauges 13 to be arranged in correct positions (above the beam portion 11c) by rotating the film 12 so that the alignment mark 12e formed on the film 12 aligns with the alignment mark 11e formed on the frame portion 11b when the film 12 is bonded to the upper face of the beam portion 11c. A method of forming the alignment marks 11e and 12e may include, for example, printing, but this is not limited thereto. The method of forming the alignment marks 11e and 12e is not particularly limited.

Difference 2: In the force sensor 1 illustrated in FIG. 1, a recess 14a is formed on the outer periphery of the film 14 and a protrusion 11d is formed on the inner side face of the frame portion 11b. In contrast, in the force sensor 1B in accordance with the present variation, no recess is formed on the outer periphery of the film 14 and no protrusion is formed on the inner side face of the frame portion 11b. Instead, in the force sensor 1B in accordance with the present variation, an alignment mark 14e is formed on the lower face of the film 14 and an alignment mark (not illustrated) is formed on the inner side face of the frame portion 11b.

This allows the strain gauges 15 to be arranged in correct positions (below the beam portion 11c) by rotating the film 14 so that the alignment mark 14e formed on the film 14 aligns with the alignment mark (not illustrated) formed on the frame portion 11b when the film 14 is bonded to the lower face of the beam portion 11c. A method of forming the alignment mark 14e may include, for example, printing, but this is not limited thereto. The method of forming the alignment mark 14e is not particularly limited.

Aspects of the present invention can also be expressed as follows:

A sensor device in accordance with Aspect 1 of the present invention includes: a strain element; and a film on which a plurality of strain gauges are formed, the film being bonded to the strain element.

With this configuration, it is possible to provide a sensor device in which the time required for mounting a plurality of strain gauges can be reduced and variation is unlikely to occur in the positional relationship among the plurality of strain gauges, irrespective of the shape and material of a strain element.

A sensor device in accordance with Aspect 2 of the present invention is the sensor device according to Aspect 1, wherein the strain element has a columnar core portion, a tubular frame portion surrounding the core portion, and a beam portion connecting the core portion and the frame portion, and the film is bonded to an upper face of the beam portion.

With this configuration, it is possible to provide a sensor device in which a strain element having a core portion, a frame portion, and a beam portion is provided, and in which the time required for mounting a plurality of strain gauges can be reduced and variation is unlikely to occur in the positional relationship among the plurality of strain gauges.

A sensor device in accordance with Aspect 3 of the present invention is the sensor device according to Aspect 2, wherein the upper face of the beam portion is positioned lower than an upper face of the core portion and an upper face of the frame portion, and the film is disposed in a space defined between a side face of the core portion and an inner side face of the frame portion, and is bonded to the upper face of the beam portion.

With this configuration, since the entire film is completely accommodated in a space defined between the side face of the core portion and the inner side face of the frame portion, damage to the strain gauges due to contact with an object is unlikely to occur even when the upper face of the sensor device is not covered by the cover.

A sensor device in accordance with Aspect 4 of the present invention is the sensor device according to Aspect 3, wherein: a protrusion is formed on the inner side face of the frame portion and a recess is formed on an outer periphery of the film, the recess being configured to engage with the protrusion; or a recess is formed on the inner side face of the frame portion and a protrusion is formed on the outer periphery of the film, the protrusion being configured to engage with the recess.

With this configuration, the alignment of the film with the strain element, that is, the alignment of the plurality of strain gauges with the strain element can be easily achieved by appropriately rotating the film so that the recess formed on the outer periphery of the film engages with the protrusion formed on the inner side face of the frame portion, or by appropriately rotating the film so that the protrusion formed on the outer periphery of the film engages with the recess formed on the inner side face of the frame portion.

A sensor device in accordance with Aspect 5 of the present invention is the sensor device according to Aspect 2 or 3, wherein a first alignment mark is formed on an inner side face or an upper face of the frame portion, and a second alignment mark is formed on an upper face of the film, the second alignment mark corresponding to the first alignment mark.

With this configuration, the alignment of the film with the strain element, that is, the alignment of the plurality of the strain gauges and the strain element can be easily achieved by appropriately rotating the film so that the alignment mark formed on the upper face of the film aligns with the alignment mark formed on the inner side face or the upper face of the frame portion.

A sensor device in accordance with Aspect 6 of the present invention is the sensor device according to any one of Aspects 2 to 5, wherein the film has: a first region in which a first strain gauge configured to be arranged on the upper face of the beam portion is formed; and a second region in which a second strain gauge configured to be arranged on a side face of the beam portion is formed, the second region being adjacent to the first region and being surrounded by a cut line that surrounds three sides except for a boundary with the first region, and the film is bent so that a boundary line between the first region and the second region serves as a ridge line, the first region is bonded to the upper face of the beam portion, and the second region is bonded to the side face of the beam portion.

With this configuration, it is possible to provide a sensor device in which strain gauges are arranged on side faces of beam portions, and in which the time required for mounting a plurality of strain gauges can be reduced and variation is unlikely to occur in the positional relationship among the plurality of strain gauges.

A sensor device in accordance with Aspect 7 of the present invention is the sensor device according to any one of Aspects 2 to 6, further including another film on which another strain gauge is formed, wherein a lower face of the beam portion is positioned higher than a lower face of the core portion and a lower face of the frame portion, and the another film is disposed in a space defined between a side face of the core portion and an inner side face of the frame portion, and is bonded to the lower face of the beam portion.

With this configuration, it is possible to provide a sensor device in which strain gauges are arranged on both the upper and the lower faces of a strain element, and in which the time required for mounting a plurality of strain gauges can be reduced and variation is unlikely to occur in the positional relationship among the plurality of strain gauges. In addition, since the entire film is completely accommodated in a space defined between the side face of the core portion and the inner side face of the frame portion, damage to the strain gauges due to contact with an object is unlikely to occur even when the lower face of the sensor device is not covered by the cover.

A film in accordance with Aspect 8 of the present invention is a film configured to be bonded to a strain element, the film including a plurality of strain gauges that are formed on the film.

With this configuration, it is possible to provide a sensor device in which the time required for mounting a plurality of strain gauges can be reduced and variation is unlikely to occur in the positional relationship among the plurality of strain gauges.

1. A sensor device comprising:
a strain element; and
a film on which a plurality of strain gauges are formed,
the film being bonded to the strain element.

2. The sensor device according to claim 1, wherein
the strain element has a columnar core portion, a tubular frame portion surrounding the core portion, and a beam portion connecting the core portion and the frame portion, and
the film is bonded to an upper face of the beam portion.

3. The sensor device according to claim 2, wherein
the upper face of the beam portion is positioned lower than an upper face of the core portion and an upper face of the frame portion, and
the film is disposed in a space defined between a side face of the core portion and an inner side face of the frame portion, and is bonded to the upper face of the beam portion.

4. The sensor device according to claim 3, wherein: a protrusion is formed on the inner side face of the frame portion and a recess is formed on an outer periphery of the film, the recess being configured to engage with the protrusion; or a recess is formed on the inner side face of the frame portion and a protrusion is formed on the outer periphery of the film, the protrusion being configured to engage with the recess.

5. The sensor device according to claim 2, wherein a first alignment mark is formed on an inner side face or an upper face of the frame portion, and a second alignment mark is formed on an upper face of the film, the second alignment mark corresponding to the first alignment mark.

6. The sensor device according to claim 2, wherein
the film has: a first region in which a first strain gauge configured to be arranged on the upper face of the beam portion is formed; and a second region in which a second strain gauge configured to be arranged on a side face of the beam portion is formed, the second region being adjacent to the first region and being surrounded by a cut line that surrounds three sides except for a boundary with the first region, and
the film is bent so that a boundary line between the first region and the second region serves as a ridge line, the first region is bonded to the upper face of the beam portion, and the second region is bonded to the side face of the beam portion.

7. The sensor device according to claim 2, further comprising another film on which another strain gauge is formed, wherein
a lower face of the beam portion is positioned higher than a lower face of the core portion and a lower face of the frame portion, and
the another film is disposed in a space defined between a side face of the core portion and an inner side face of the frame portion, and is bonded to the lower face of the beam portion.

8. A film configured to be bonded to a strain element, the film comprising a plurality of strain gauges that are formed on the film.
